(19) United States
(12) Patent Application Publication
(10) Pub. No.: US 2015/0277677 A1
(43) Pub. Date: Oct. 1, 2015

(54) INFORMATION PRESENTATION TECHNIQUES FOR DIGITAL CONTENT

(71) Applicant: Kobo Incorporated, Toronto (CA)

(72) Inventor: James WU, Toronto (CA)

(73) Assignee: Kobo Incorporated, Toronto (CA)

(21) Appl. No.: 14/226,605

(22) Filed: Mar. 26, 2014

(51) Int. Cl. G06F 3/0483; G06F 3/0484; G06F 3/0488; G06F 3/0481

(52) U.S. Cl. CPC G06F 3/0483; G06F 3/0481; G06F 3/04847; G06F 3/04886

(57) ABSTRACT

Techniques for presenting an electronic copy of a book include displaying a section of the book on a first portion of a display and a scrubber on a second portion. The scrubber includes a first condensed region representing a first set of chapters. A fanned region of the scrubber represents the pages of a given chapter. A second condensed region represents a second set of chapters. The first condensed region, the fanned region and second condensed region are linearly arranged in the second portion of the display, wherein the representation of pages of the given chapter occurs sequentially between the chapters of the first and second sets.

### BACKGROUND OF THE INVENTION

Electronic devices have made significant contributions toward the advancement of modern society and are utilized in a number of applications to achieve advantageous results. Numerous devices, such as desktop personal computers (PCs), laptop PCs, tablet PCs, netbooks, eBooks, eReaders, smart phones, servers, and the like have facilitated increased productivity and reduced costs in communicating and analyzing data in most areas of entertainment, education, business, and science.

When reading content such as books, periodicals, and the like, there are a number of techniques utilized to provide information concerning the content to a user. Conventional techniques generally include a scrubber that provides some basic information about the content. The scrubber typically has a bar with a handle that can be moved backwards and forward to move backward and forwards through the content. The scrubber may also include buttons to move forward and backward page by page or skip directly to the beginning or end of the content. The scrubber may also provide some information about the content such as the current page being read, the total number of pages in the item of content, the title of the content and/or the author of the content However, there is a continuing need for improved scrubber interfaces that intuitively present a representation of the item of content along with pertinent information to improve the reader experience.

### SUMMARY OF THE INVENTION

The present technology may best be understood by referring to the following description and accompanying drawings that are used to illustrate embodiments of the present technology directed toward a scrubber interface for presenting information concerning an item of content.

In one embodiment, a graphical user interface is adapted to present a section of a multi-level item of content in a content presenting portion of a display. The graphical user interface is also adapted to present a scrubber in a content information presenting portion of the display. The scrubber includes one or more condensed regions and a fanned region. The one or more condensed regions represent a plurality of units of a first level of the item of content. The fanned region represents a plurality of units of a second level of the item of content corresponding to a given additional unit of the first level of the item of content. In one implementation, the item of content is an electronic version of a book, the units of the first level are the chapters of the book, and the units of the second level are the pages of the book.

In another embodiment, a method includes presenting, a section of a multi-level item of content on a first portion of a display, and presenting, a scrubber on a second portion of the display. The scrubber includes a first condensed region representing a first set of units of a first level of the item of content. The scrubber also includes a fanned region representing a plurality of units of a second level of a given unit of the first level of the item of content. The scrubber further includes a second condensed region representing a second set of units of the first level of the item of content The first condensed region, the fanned region and second condensed region are linearly arranged. The given unit of the first level of the item of content occurs sequentially between the units of the first level in the first set and the units of the first level in the second set.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Embodiments of the present technology are illustrated by way of example and not by way of limitation, in the figures of the accompanying drawings and in which like reference numerals refer to similar elements and in which:

FIGS. 1-6 show a graphical user interface for presenting content on a display, in accordance with embodiments of the present technology.

FIGS. 7-9 show a graphical user interface for presenting content on a display, in accordance with other embodiments of the present technology.

FIG. 10 shows a block diagram of an exemplary electronic device for implementing embodiments of the present technology.

FIG. 11 shows a flow diagram of a method of displaying content along with a page edge scrubber interface, in accordance with embodiments of the present technology.

FIG. 12 shows a flow diagram of a method of displaying content along with a gauge scrubber interface, in accordance with embodiments of the present technology.

### DETAILED DESCRIPTION OF THE INVENTION

Reference will now be made in detail to the embodiments of the present technology, examples of which are illustrated in the accompanying drawings. While the present technology will be described in conjunction with these embodiments, it will be understood that they are not intended to limit the invention to these embodiments. On the contrary, the invention is intended to cover alternatives, modifications and equivalents, which may be included within the scope of the invention as defined by the appended claims. Furthermore, in the following detailed description of the present technology, numerous specific details are set forth in order to provide a thorough understanding of the present technology. However, it is understood that the present technology may be practiced without these specific details. In other instances, well-known methods, procedures, components, and circuits have not been described in detail as not to unnecessarily obscure aspects of the present technology.

Some embodiments of the present technology which follow are presented in terms of routines, modules, logic blocks, and other symbolic representations of operations on data within one or more electronic devices. The descriptions and representations are the means used by those skilled in the art to most effectively convey the substance of their work to others skilled in the art. A routine, module, logic block and/or the like, is herein, and generally, conceived to be a self-consistent sequence of processes or instructions leading to a desired result. The processes are those including physical manipulations of physical quantities. Usually, though not necessarily, these physical manipulations take the form of electric or magnetic signals capable of being stored, transferred, compared and otherwise manipulated in an electronic device. For reasons of convenience, and with reference to common usage, these signals are referred to as data, bits, values, elements, symbols, characters, terms, numbers, strings, and/or the like with reference to embodiments of the present technology.

It should be borne in mind, however, that all of these terms are to be interpreted as referencing physical manipulations and quantities and are merely convenient labels and are to be interpreted further in view of terms commonly used in the art. Unless specifically stated otherwise as apparent from the following discussion, it is understood that through discussions of the present technology, discussions utilizing the terms such as “receiving,” and/or the like, refer to the actions and processes of an electronic device such as an electronic computing device that manipulates and transforms data. The data is represented as physical (e.g., electronic) quantities within the electronic device's logic circuits, registers. memories and/or the like, and is transformed into other data similarly represented as physical quantities within the electronic device.

In this application, the use of the disjunctive is intended to include the conjunctive. The use of definite or indefinite articles is not intended to indicate cardinality. In particular, a reference to “the” object or “a” object is intended to denote also one of a possible plurality of such objects. It is also to be understood that the phraseology and terminology used herein is for the purpose of description and should not be regarded as limiting.

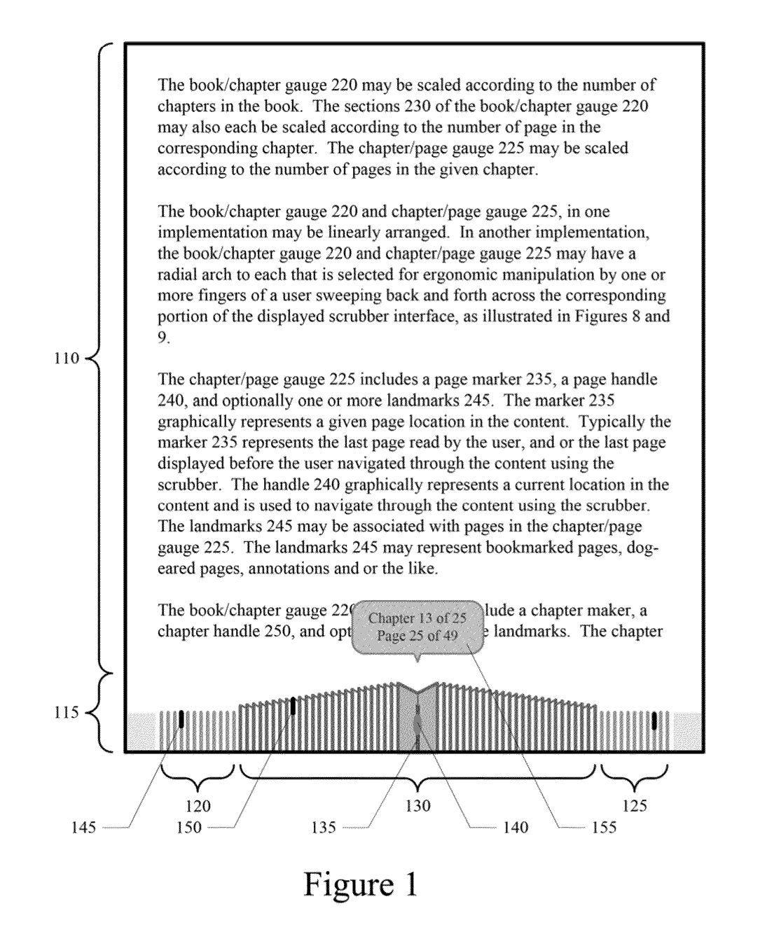

FIGS. 1-6 show a graphical user interface for presenting content on a display, in accordance with embodiments of the present technology. The graphical user interface includes a content presenting portion 110 and a content information presenting portion 115. The content presenting portion 110 may present a section of the content on the display to a user. The section of the content may be a plurality of lines of text, one or more paragraphs of text, a page of text, or the like. The section of the content may also, or in the alternative, include one or more graphics, pictures, tables, charts, and or the like.

The content information presenting portion 115 will be referred to hereinafter as the scrubber, or more particularly as page edge scrubber interface. The page edge scrubber 115 includes one or more condensed regions 120, 125, a fanned region 130, a marker 135, and a handle 140. The fanned region 130 graphically represents the individual pages of a given chapter by indicator markings fanned out analogous to pages of a printed book so that the pages can be individually selected, addressed, manipulated and/or the like. In one implementation, the fanned region 130 may display the indicator markings fanned out analogous to pages of a primed book in the shape of a fan. The fanned region 130 may be magnified with respect to the condensed regions 120, 125. The condensed regions 120, 125 graphically represent the chapters before and or after the given chapter represented in the fanned region 130. The condensed region on the left side 120 graphically represents chapters before the current chapter represented in the fanned region 130. The condensed region on the right side 125 graphically represents chapters after the current chapter represented in the fanned region 130.

The fanned region 130 and condensed regions 120, 125 may each be scaled to enable a user to visually perceive page based progress through the current chapter and or the chapter based progress through the book. In particular, the width of the fanned region 130 may be sized proportionally relative to the number of pages in the given chapter, as well as the number of chapters in the book. The condensed regions 120, 125 may each be sized proportionally relative to the number of chapter in the book before and/or after the given chapter represented in the fanned region 130.

The marker 135 graphically represents a given location in the content. Typically the marker 135 represents the last page read by a user, and or the last page displayed before the user started navigating through the content using the scrubber. The handle 140 graphically represents a current location in the content and is used to navigate through the content using the scrubber.

The scrubber interface 115 may also include one or more landmarks 145, 150, 190. The landmarks 145, 150 may be associated with pages in the fanned region 130 or chapters in the condensed regions 120, 125. The landmarks may represent bookmarked pages, dog-eared pages, annotated pages, and/or the like. Dog-eared pages may be representative of pages having a corner folded over. Annotated pages may have notes, comments or the like added. to thereto.

The scrubber interface 115 may also include a supplemental data window 155. The supplemental data window 155 may be displayed for a predetermined period of time after one or more scrubber based inputs. The supplemental data window 155 may display data concerning the content including the current chapter number corresponding to the position of the handle, the number of pages in the current chapter, the percentage of pages read or remaining in a given chapter, the number of chapters in the book, the percentage of chapters read or remaining in the book, the current chapter heading, the title of the book, the current page number corresponding to the position of the handle, the number of pages in the book, any data associated with one or more landmarks, and or the like. For example, when an input event, proximate a given page in the fanned region, a given chapter in the condensed region, the handle, the marker and/or a given landmark is received, additional data associated therewith may be displayed in the supplemental data. window. The additional data may be displayed adjacent the associated graphical representation of the given page in the fanned region, the given chapter in the condensed region, the handle, the marker or the given landmark, and or overlaying a portion of content currently being displayed.

Different colors, textures, shading, magnification, animation and/or the like can be applied to the various elements of the scrubber interface. For instance, a first set of color, texture and shading parameters can be applied to the chapter indicators of the condensed regions 120, 125. For example, lines of a given shade of gray may be used to indicate each chapter in the condensed regions 120, 125. A slightly different set of color, texture and shading parameters can be applied to the page indicators of the fanned region 130, except for the current fanned page indicator which may be given a unique set of color, texture and shading. For example, a darker shade of gray may be used to indicate each page of the current chapter in the condensed region 130, except for the current page which may be represent in a light shade of blue. A unique set of color, texture and shading parameters may be applied to the marker 135. For example, a line of a darker shade of blue may be used to represent the marker 135. Similarly, another unique set of color, texture and shading parameters may be applied to the handle 140. For example, a rose colored circle or oval may be used to represent the handle 140. Furthermore, other unique sets of color, texture and shading parameter may be applied to different types of landmarks. For example, dog-eared pages may be represented by a green tip of the corresponding page indicator in the fanned region 130, or green tip of the corresponding chapter indicator in the condensed regions 120, 125. Annotated pages may be represented by corresponding red tips. Furthermore, the colors, textures, shading, magnification, animation and/or the like parameters of a given element, or group of elements may change in response to one or more events. For example, the handle may be represented by a first color when it is stationary, and a second color when it is moving in response to an applicable user input.

Similarly, one or more levels of magnification can be applied to one or more elements and/or sets of elements. In addition, any level of magnification may be constant or spatially graduated. For example, a first level of magnification can be applied to the fanned region 130 when the handle 140 and marker 135 are positioned within the same chapter. A second level of magnification may he applied to the fanned region 130, while the marker 135 is located in the given chapter represented by the fanned region 130, and the handle 140 is moving, in response to a user input, in the condensed region 120, 125. When the handle 140 is being, moved in the condensed region 120, 125 outside of the fanned region 130, the chapter indicator lines may be magnified at a third spatially graduated level about the handle 140. If the handle 140 pauses for at least a predetermined period of time in the condensed region 120, 125, the fanned region 130 may shift to the chapter where the handle 140 is paused.

Furthermore, when the handle 140 is moving in the fanned region 130, the page indicators may he animated to represent the turning of pages as the handle 140 is moving. Likewise the supplemental data window may move side to side in concert with movement of the handle 140, and display data corresponding to the particular page indicator or chapter indicator that the handle is currently located at.

In one implementation, the scrubber interface 115 is continuously displayed along with the content presenting portion 110. In another implementation, the scrubber interface 115 is displayed in response to a corresponding user input such as tapping along a bottom edge of content presenting portion 110. After a predetermined period of display without any user input pertaining to further scrubber functions, the scrubber interface 115 may be hidden and the content presenting portion 110 can be expanded. to till the remainder of the display screen.

The page edge scrubber interface 115 intuitively presents a representation of the book along with pertinent information. The elements of the scrubber enable a user to determine approximately, at a glance, where they are in the book. A user can also determine approximately, at a glance, how much is left to reading the chapter. A user can also determine approximately, at a glance, how much is left to read in the book. A user can also determine approximately, at a glance, where bookmarks and annotations are. A user can also serendipitously discover his or her bookmarks. A user can also readily scan ahead in the chapter or in the book as a whole. A user can also readily flip backward to re-read section of the chapter or the book. A user can also readily get back to where he or she was reading before they started flipping through the chapter or book. A user can also readily scan for specific areas in the chapter or the book. A user can also readily find pieces of text in the book that they remember. A user can also readily re-read sections to refresh their context in the book. Furthermore, a user can readily have their place in the book held.

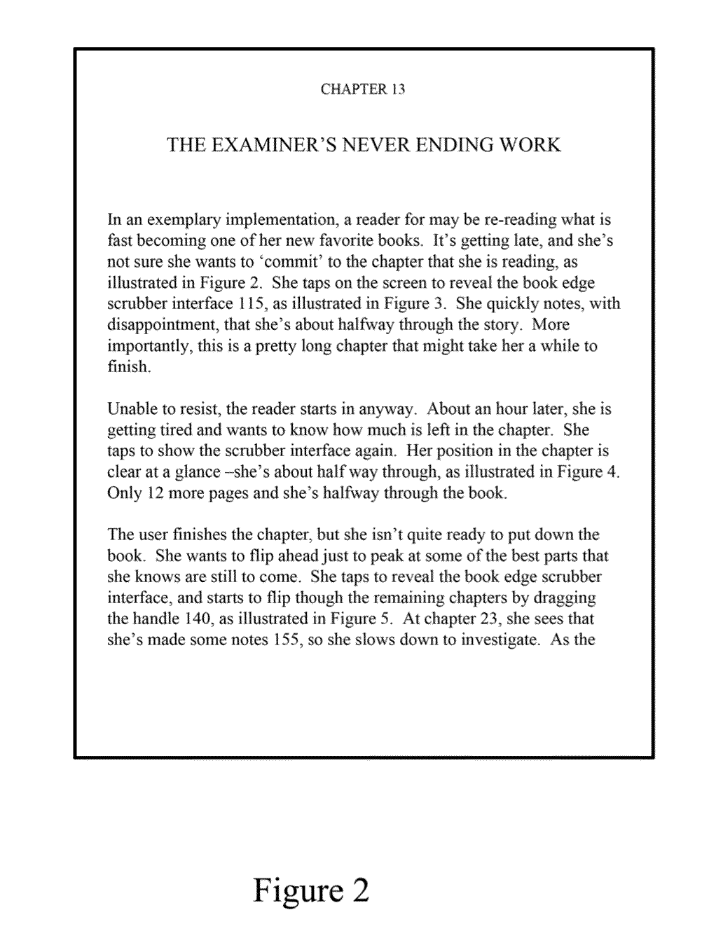

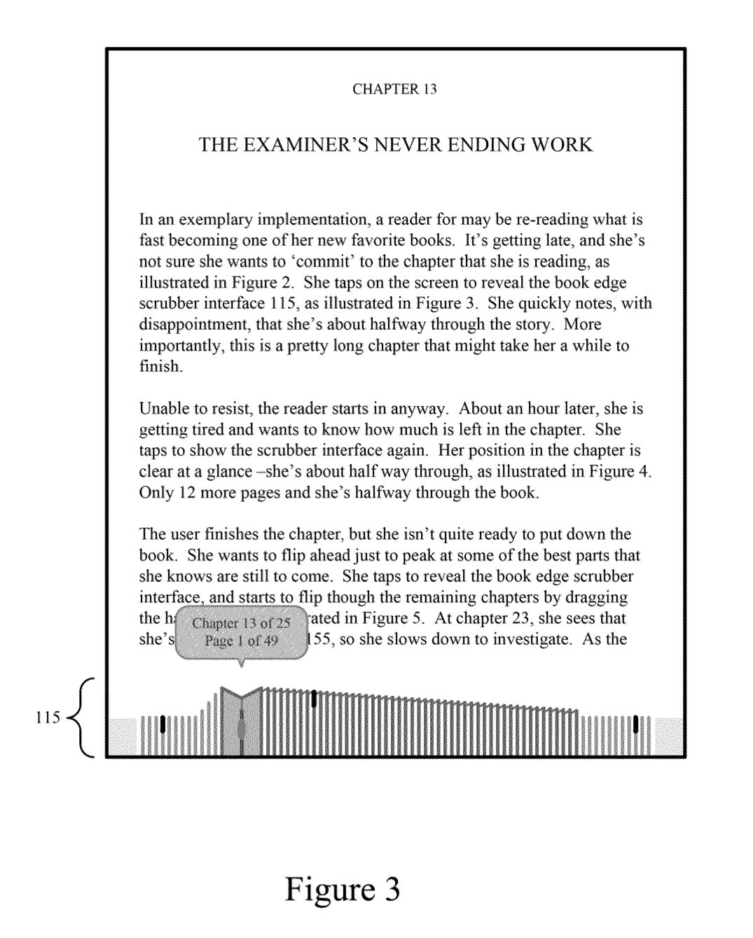

In an exemplary implementation, a reader for may be re-reading what is fast becoming one of her new favorite books. It's getting late, and she's not sure she wants to ‘commit’ to the chapter that she is reading, as illustrated in FIG. 2. She taps on the screen to reveal the book edge scrubber interface 115, as illustrated m FIG. 3. She quickly notes, with disappointment, that she's about halfway through the story. More importantly, this is a pretty long chapter that might take her a while to finish.

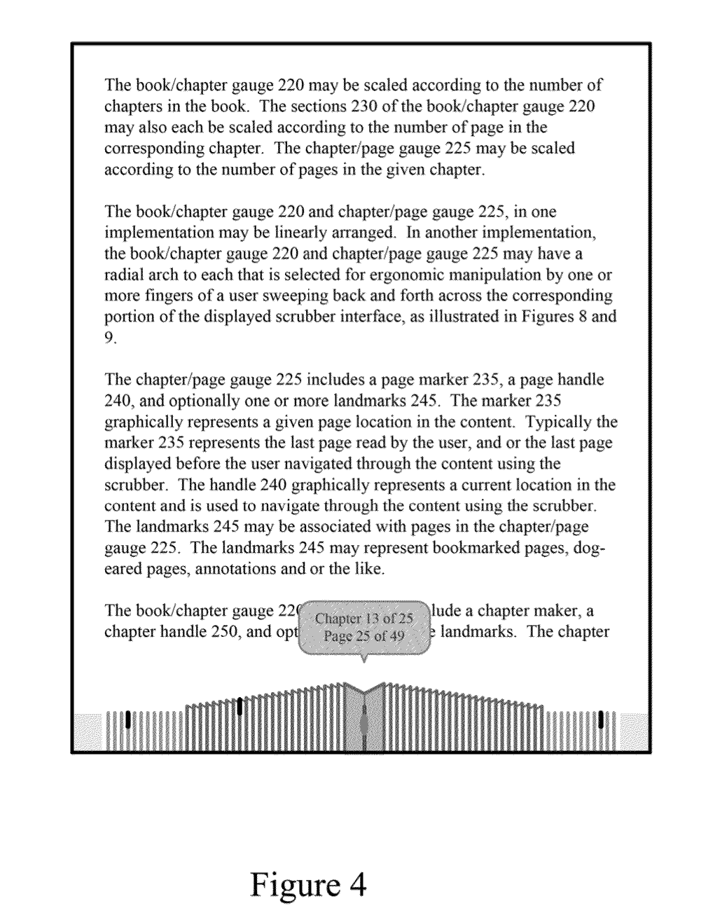

Unable to resist, the reader starts in anyway. About an hour later, she is getting tired and wants to know how much is left in the chapter. She taps to show the scrubber interface again. Her position in the chapter is dear at a glance—she's about half way through, as illustrated in FIG. 4. Only 12 more pages and she's halfway through the book.

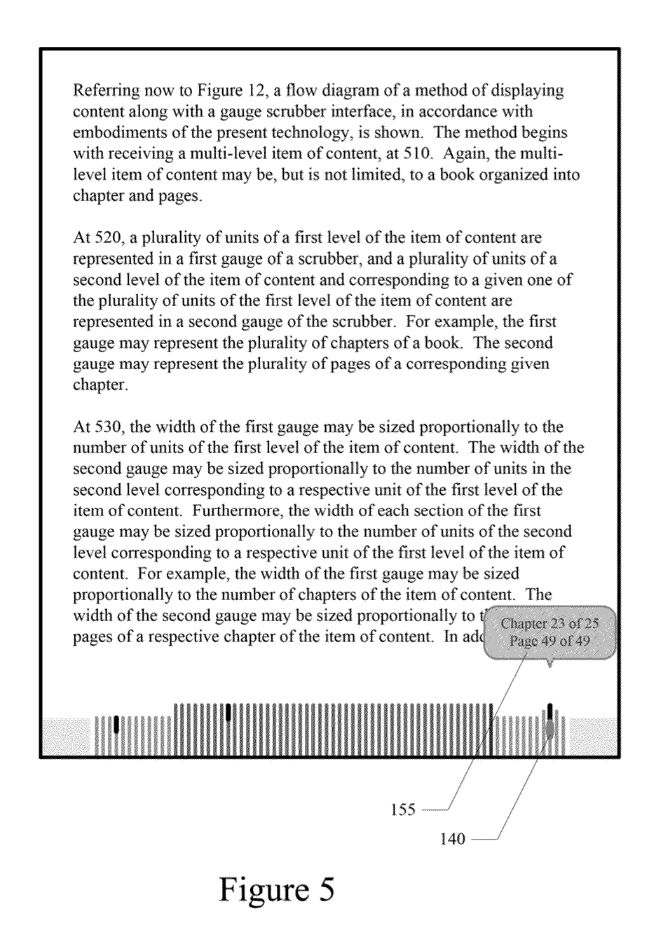

The user finishes the chapter, but she isn't quite ready to put down the book. She wants to flip ahead just to peak at some of the best parts that she knows are still to come. She taps to reveal the book edge scrubber interface, and starts to flip though the remaining chapters by dragging the handle 140, as illustrated in FIG. 5. At chapter 23, she sees that she's made some notes 155, so she slows down to investigate. As the pages of chapter 23 fan-out, she can see the individual dog-ears she made. She flips slowly to each landmark, browsing the notes and annotations that she made last time through.

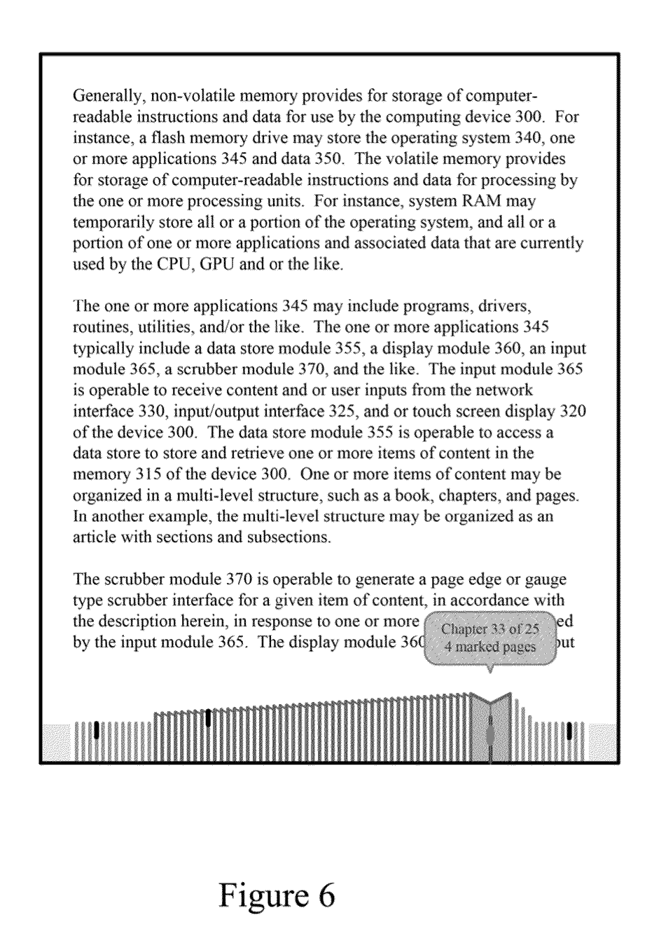

Done for the night, the user wants to get back to where she left off, so she can close her book to get some sleep. She flips back to the marker indicating her current place in the book, as illustrate in FIG. 6. She taps the book edge to hide the scrubber interface, and then exits the book.

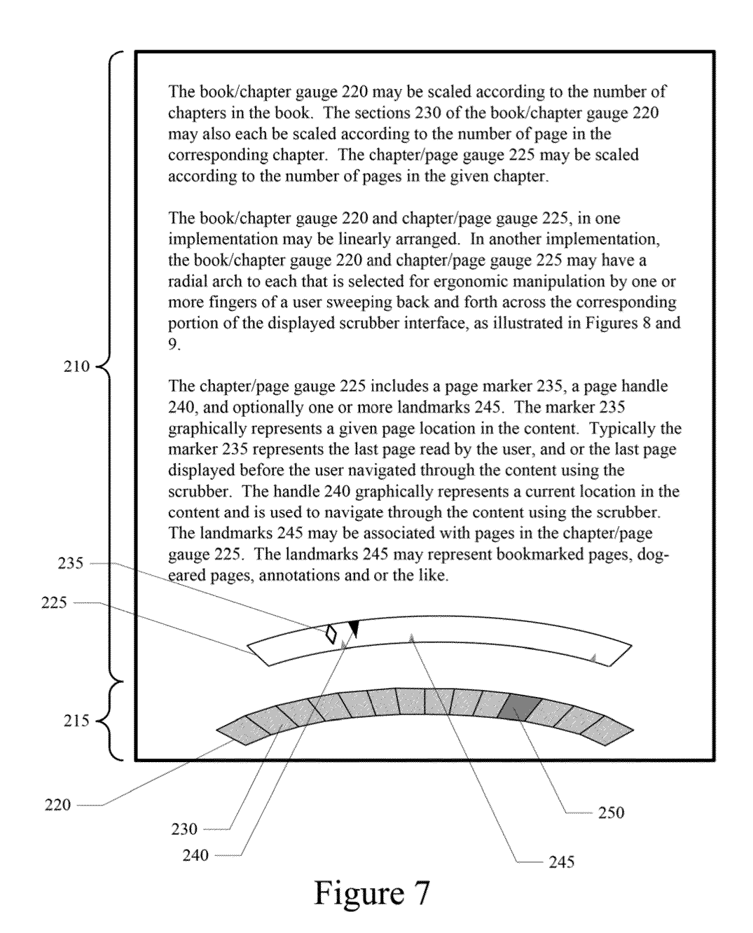

Referring now to FIGS. 7-9, a graphical user interface for presenting content on a display, in accordance with other embodiments of the present technology, is shown. The graphical user interface includes a content presenting portion 210 and a content information presenting portion 215. The content information presenting portion 215 will be referred to herein after as the scrubber, or more particularly a gauge scrubber interface. The gauge scrubber 215 includes a book/chapter gauge 220 and a chapter/page gauge 225. The book/chapter gauge 220 graphically represents the chapters of the book in corresponding sections 230. The chapter/page gauge 225 graphically represents the pages of a given chapter selected in the book/chapter gauge 220.

The book/chapter gauge 220 may be scaled according to the number of chapters in the book. The sections 230 of the book/chapter gauge 220 may also each be scaled according to the number of page in the corresponding chapter. The chapter/page gauge 225 may be scaled according to the number of pages in the given chapter.

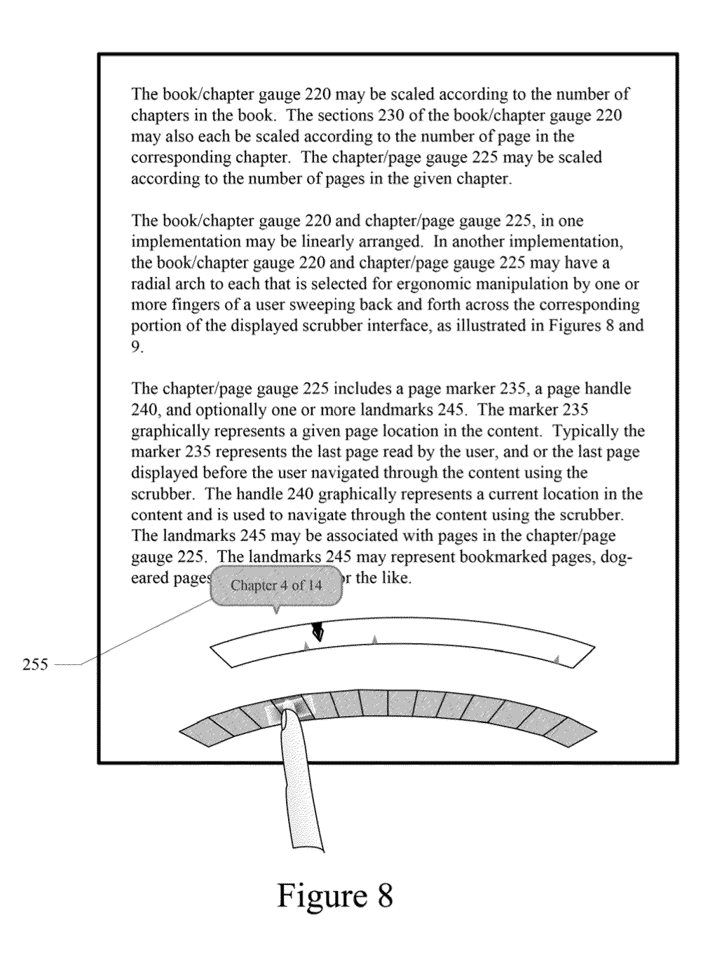

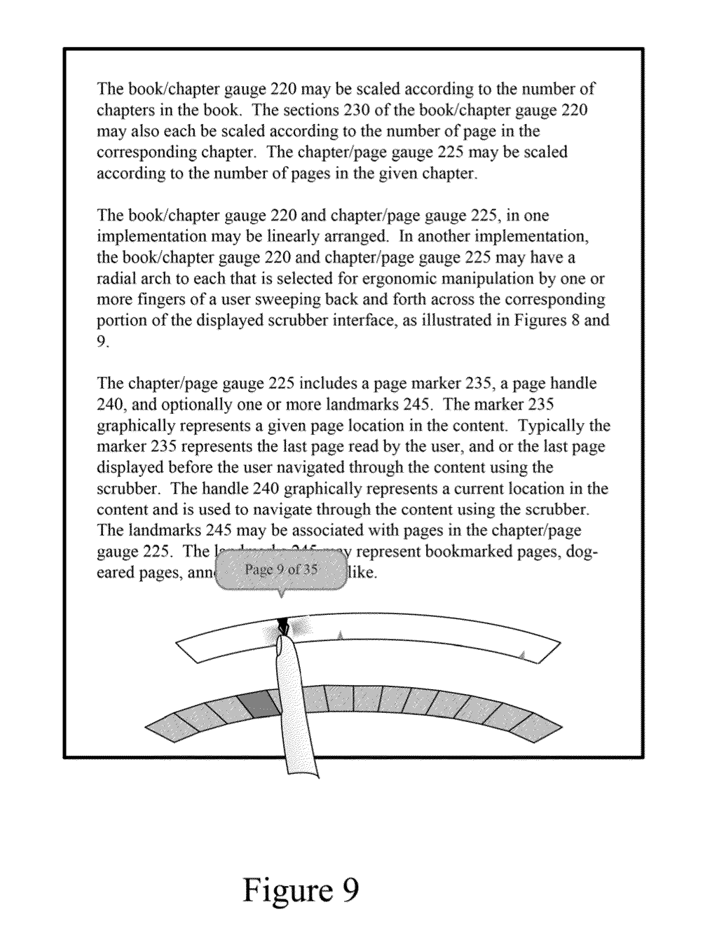

The book/chapter gauge 220 and chapter/page gauge 225, in one implementation may be linearly arranged. In another implementation, the book/chapter gauge 220 and chapter/page gauge 225 may have a radial arch to each that is selected for ergonomic manipulation by one or more lingers of a user sweeping back and forth across the corresponding portion of the displayed scrubber interface, as illustrated in FIGS. 8 and 9.

The chapter/page gauge 225 includes a page marker 235, a page handle 240, and optionally one or more landmarks 245. The marker 235 graphically represents a given page location in the content. Typically the marker 235 represents the last page read by the user, and or the last page displayed before the user navigated through the content using the scrubber. The handle 240 graphically represents a current location in the content and is used to navigate through the content using the scrubber. The landmarks 245 may be associated with pages in the chapter/page gauge 225. The landmarks 245 may represent bookmarked pages, dog-eared pages, annotations and or the like.

The book/chapter gauge 220 may similarly include a chapter maker, a chapter handle 250, and optionally one or more landmarks. The chapter marker graphically represents a given chapter in the content. The chapter handle 250 graphically represents a current chapter location in the content and is used to navigate through the content using the scrubber. The landmarks may also be associated with chapters in the book/chapter gauge 220. The landmarks in the book/chapter gauge 220 may represent the aggregation of one or more bookmarked pages, dog-eared pages, annotations and or the like in a corresponding chapter.

The scrubber interface 215 may also include a supplemental data. window 255 as illustrated in FIG. 8. The supplemental data window 255 may be displayed for a predetermined period of time after one or more scrubber based inputs. The supplemental data window 255 may display data concerning the content including the current chapter number, the number of pages in the current chapter, the percentage of pages read or remaining in a given chapter, the number of chapters in the book, the percentage of chapters read or remaining in the book, the current chapter heading, the title of the book, the current page number, the number of pages in the book, any data associated with one or more landmarks, and/or the like. For example, when an input event proximate a given page in the chapter/page gauge 220, a given chapter in the book/chapter gauge 225, the handle, the marker and/or a given landmark is received additional data associated therewith may be displayed in the supplemental data window 255. The additional data associated with the given page in the chapter/page gauge 225, a given chapter in the book/chapter gauge 220, the marker, the handle, or the given landmark may be displayed adjacent the applicable portion of the gauge scrubber interface and/or overlaying as portion of content currently being displayed.

Different colors, textures, shading, magnification, animation and/or the like can be applied to the various elements of the gauge scrubber interface 215. For instance, a first set of color, texture and shading parameters can be applied to the chapter sections 230 of the book/chapter gauge. For example, a given shade of gray may be used to indicate the section 250 corresponding to the current chapter in the book/chapter gauge, while a similar but lighter shade of gray is used to indicate the sections 230 corresponding to the other chapters. A unique set of color, texture and shading parameters may be applied to the marker 235. For example, a diamond of a darker shade of blue may be used to represent the marker 235 Similarly, another unique set of color, texture and shading parameters may be applied to the handle. For example, a black colored arrow may be used to represent the handle 240. Furthermore, other unique sets of color, texture and shading parameters may be applied to different types of landmarks 245. For example, dog-eared pages may be represented by green arrows. Annotated pages may represented by corresponding red arrows. Furthermore, the colors, textures, shading, magnification, animation and/or the like parameters of a given element or group of elements may change in response to one or more events. For example, the handle may be represented by a first color when it is stationary, and a second color when it is moving in response to an applicable user input.

In one implementation, the gauge scrubber interface 215 is continuously displayed along with the content presenting portion 210. In another implementation, the scrubber interface 215 is displayed in response to a corresponding user input such as tapping along a bottom edge of content presenting portion 110. After a predetermined period of display without any user input pertaining to further scrubber functions, the scrubber interface 215 may be hidden and the content presenting portion 210 can be expanded to fill the remainder of the display screen.

The gauge scrubber interface 215 intuitively presents a representation of the book along with pertinent information. The elements of the scrubber enable a user to determine approximately, at a glance, where they are in the book. A user can also determine approximately, at a glance, how much is left to reading the chapter. A user can also determine approximately, at a glance, how much is left to read in the book. A user can also determine, approximately, at a glance, where bookmarks and annotations are. A user can also serendipitously discover his or her bookmarks. A user can also readily scan ahead in the chapter or in the book as a whole. A user can also readily flip backward to re-read section of the chapter or the book. A user can also readily get back to where he or she was reading before they started flipping through the chapter or book. A user can also readily scan for specific areas in the chapter or the book. A user can also readily find pieces of text in the book that they remember. A user can also readily re-read sections to refresh their context in the book. Furthermore, a user can readily have their place in the book held.

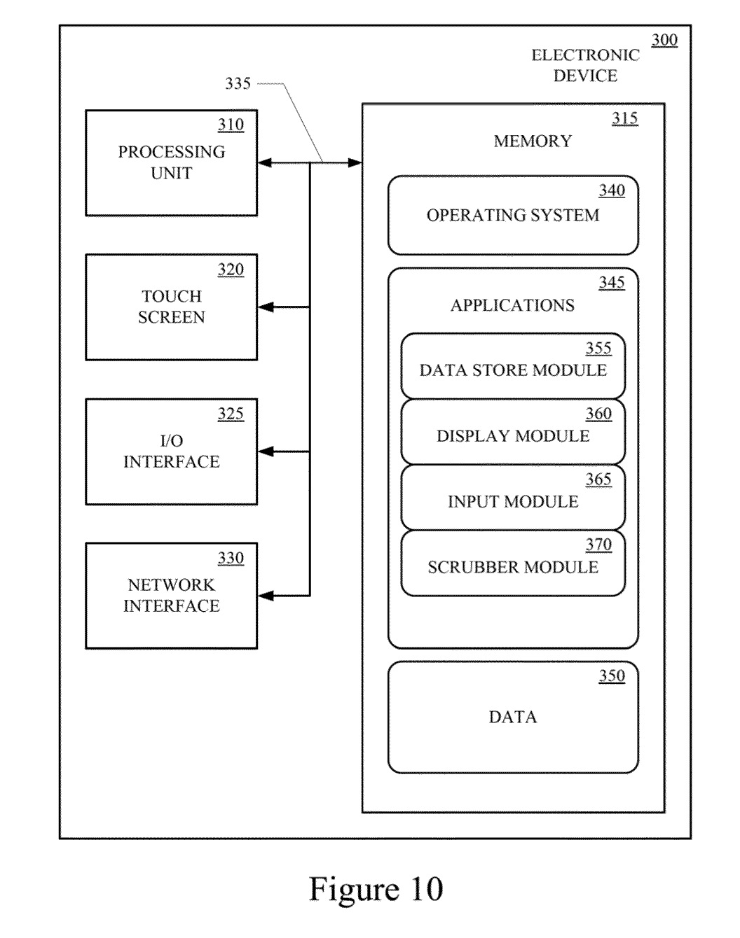

The graphical user interface may be implemented as computing device-executable instructions (e.g., computer program) that are stored in computing device-readable media (e.g., computer memory) and executed by a computing device (e.g., processor). Referring now to FIG. 10, an exemplary electronic device for implementing embodiments of the present technology. The electronic device 300 may be an eBook, eReader, tablet, phablet, smart phone, or the like.

The electronic device 300 includes, but is not limited to, one or more processing, units 310, memory 315, a touch screen display 320, one or more input/output interfaces 325, one or more network interfaces 330 and the like communicatively coupled together by one or more communication buses 335. The one or more processing units 310 may include one or more central processing units (CPUs), one or more graphics processing units (GPUs), one or more controllers and/or the like. The memory 31 may include one or more volatile memory units such as random access memory (RAM) and one or more non-volatile memory units such as solid state memory units, magnetic disk memory units and or the like. The one or more input/output devices 325 may include a speaker, a microphone, one or more buttons, a keyboard, a pointing device and or the like. The network interface 330 may include, one or more wired communication ports (e.g., HDMI, USB, Ethernet), one or more wireless network radios (e.g., WIFI, Bluetooth), and/or the like. The one or more communication buses 335 are adapted to communicate data and instructions between the one or more processing units 310, memory 315, the touch screen display 320, one or more input output interfaces 325 one or more network interfaces 330 and the like.

The network interfaces 330 may be utilized to readily load applications and data into the memory 315 of the electronic device 300. The data includes one or more pieces of content, each organized in a multi-level structure, such as a book, including a plurality of chapter, with each chapter including a plurality of pages.

Generally, non-volatile memory provides for storage of computer-readable instructions and data for use by the computing device 300. For instance, a flash memory drive may store the operating system 340, one or more applications 345 and data 350. The volatile memory provides for storage of computer-readable instructions and data for processing by the one or more processing units. For instance, system RAM may temporarily store all or a portion of the operating system, and all or a portion of one or more applications and associated data that currently used by the CPU, GPU and or the like.

The one or more applications 345 may include programs, drivers, routines, utilities, and/or the like. The one or more applications 345 typically include a data store module 355, a display module 360, an input module 365, a scrubber module 370, and the like. The input module 365 is operable to receive content and or user inputs from the network interface 330, input/output interface 325, and or touch screen display 320 of the device 300. The data store module 355 is operable to access a data store to store and retrieve one or more items of content in the memory 315 of the device 300. One or more items of content may be organized in a multi-level structure, such as a book, chapters, and pages. In another example, the multi-level structure may be organized as an article with sections and subsections.

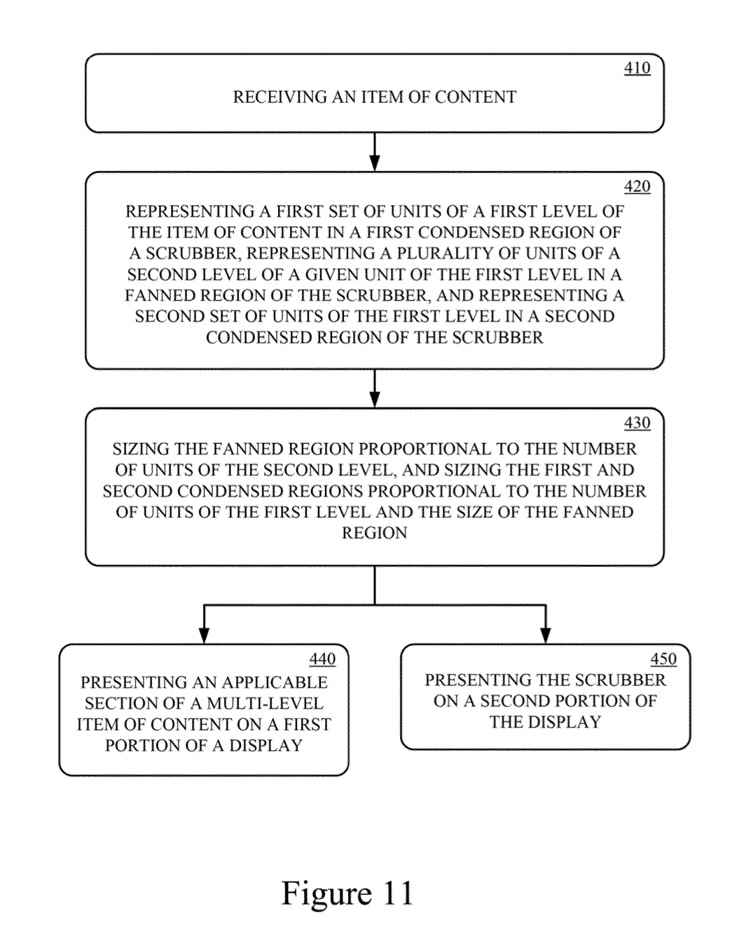

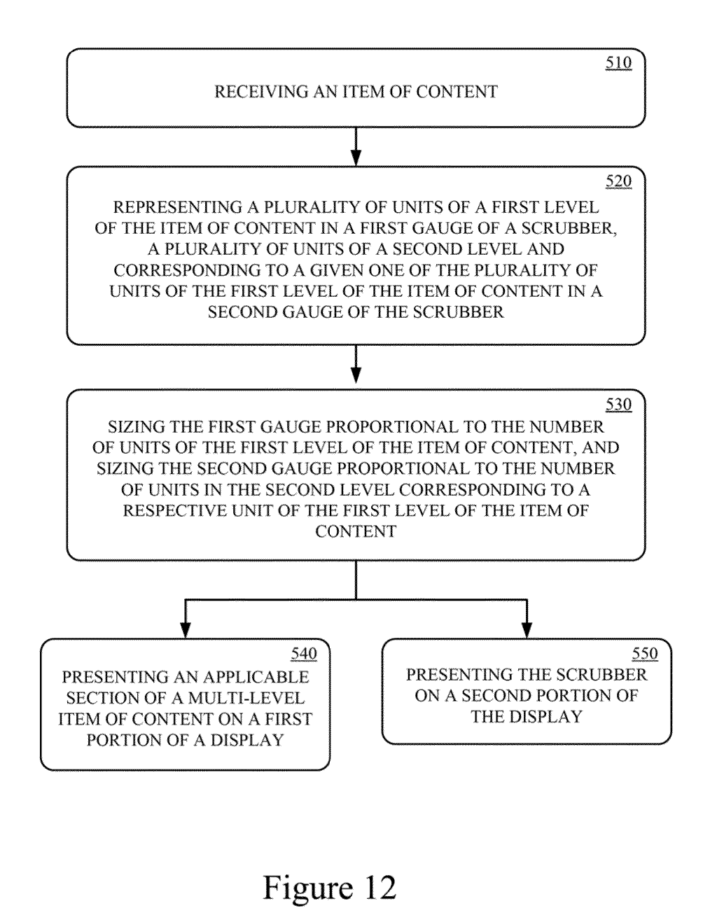

The scrubber module 370 is operable to generate a page edge or gauge type scrubber interface, for a given item of content, in accordance with the description herein, in response to one or more commands processed by the input module 365. The display module 360 is operable to output a particular portion of the given item of content on the touch screen 320, along with the scrubber interface when applicable. Exemplary operation of the display module 360 and scrubber module 370 is further explained with reference to FIGS. 11 and 12.

Referring, now to FIG. 11, a flow diagram of a method of displaying content along with a page edge scrubber interface, in accordance with embodiments of the present technology, is shown. The method begins with receiving a multi-level item of content, at 410. The multi-level item of content may be, but is not limited, to a book organized into chapter and pages. In another example, the multi-level item of content may be a paper organized into sections and subsections.

At 420, a first set of units of a first level of the item of content are represented in a first condensed region of a scrubber. A plurality of units of a second level, of a given unit of the first level of content, are represented in a fanned region of the scrubber. A second set of unit of the first level of the item of content are represented in a second condensed region of the scrubber. The first condensed region, the fanned region and the second condensed region may be linearly arranged, wherein the given unit of the first level of the item of content occurs sequentially between the units of the first level in the first set and the units of the first level in the second set.

For example, the first condensed region represents a first set of chapters, the fanned region represents pages of a given chapter, and the second condensed region represents a second set of chapters of a book. The first condensed region, the fanned region and second condensed region are linearly arranged such that the pages of the given chapter in the fanned region occur sequentially between the chapters of the first and second set in the respective first and second condensed regions.

At 430, the fanned region may be sized proportional to the number of units of the second level and a width of the first and second condensed regions. In addition, the width of the first and second condensed regions may be sized proportionally to the number of units of the first level and the width of the fanned region. For example, the width of the fanned region may be sized proportional to the number of pages in the given chapter and as width of the first and second condensed regions. The width of the first and second condensed regions may be sized proportionally to the number of chapters and the width of the fanned region.

At 440, an applicable section of a multi-level item of content is presented on a first portion of a display. In addition, the scrubber is presented on a second portion of the display, at 450.

Referring now to FIG. 12, a flow diagram of a method of displaying content along with a gauge scrubber interface, in accordance with embodiments of the present technology, is shown. The method begins with receiving a multi-level item of content, at 510. Again, the multi-level item of content may be, but is not limited, to a book organized into chapter and pages.

At 520, a plurality of units of a first level of the item of content are represented in a first gauge of a scrubber, and a plurality of units of a second level of the item of content and corresponding to a given one of the plurality of units of the first level of the item of content are represented in a second gauge of the scrubber. For example, the first gauge may represent the plurality of chapters of a book. The second gauge may represent the plurality of pages of a corresponding given chapter.

At 530, the width of the first gauge may be sized proportionally to the number of units of the first level of the item of content. The width of the second gauge may be sized proportionally to the number of units in the second level corresponding to a respective unit of the first level of the item of content. Furthermore, the width of each section of the first gauge may be sized proportionally to the number of units of the second level corresponding to a respective unit of the first level of the item of content. For example, the width of the first gauge may be sized proportionally to the number of chapters of the item of content. The width of the second gauge may be sized proportionally to the number of pages of a respective chapter of the item of content. In addition, width of each section of the first gauge representing a corresponding chapter may be sized proportionally to the number of pages in the respective chapter.

At 540, an applicable section of a multi-level item of content is presented on a first portion of a display. In addition, the scrubber is presented on a second portion of the display, at 550.

The scrubber, in accordance with embodiments of the present technology described herein, advantageously addresses specific reading behaviors such that use of the scrubber is better integrated with the reading experience and contribute to a more immersive and natural overall reading experience.

The foregoing descriptions of specific embodiments of the present technology have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is intended that the scope of the invention be defined by the claims appended hereto and their equivalents.

What is claimed is:

1. A graphical user interface comprising:
a content presenting portion for displaying a section of a multi-level item of content; and
a scrubber including one or more condensed regions and a fanned region, wherein the one or more condensed regions represent a plurality of units of a first level of the item of content and the fanned region represents a plurality of units of a second level of the item of content corresponding to a given additional unit of the first level of the item of content.

2. The graphical user interface according to claim 1, wherein:
the plurality of units of the first level composes a plurality of chapters; and
the plurality of units of the second level comprises a plurality of pages.

3. The graphical user interface according to claim 1, wherein one condensed region represents one or more units of the first level occurring prior to the given one of the plurality of units of the first level of the item of content.

4. The graphical user interface according to claim 1, wherein one condensed region represents one or more units of the first level occurring after the given one of the plurality of units of the first level of the item of content.

5. The graphical user interface according to claim 1, wherein:
a width of the fanned region is sized proportional to the number of units of the second level; and
a width of the one or more condensed regions are sized proportional to the number of units of the first level and the width of the fanned region.

6. The graphical user interface according to claim 1, wherein the scrubber further comprises a marker representing a given location in the item of content.

7. The graphical user interface according to claim 1, wherein:
the scrubber further comprises a handle representing a current location in the item of content and is adapted to select any location in the item of content; and
wherein the content presenting portion displays a section of the multi-level item of content corresponding to the current location associated with the handle.

8. A method comprising:
presenting a section of a multi-level item of content on a first portion of a display;
presenting a scrubber on a second portion of the display, wherein the scrubber includes,
a first condensed region representing a first set of units of a first level of the item of content;
a fanned region representing a plurality of units of a second level of a given unit of the first level of the item of content; and
a second condensed region representing a second set of units of the first level of the item of content; and
wherein the first condensed region, the fanned region and second condensed region are linearly arranged, and
wherein the given unit of the first level of the item of content occurs sequentially between the units of the first level in the first set and the units of the first level in the second set.

9. The method of claim 8, further comprising:
sizing a width of the fanned region proportional to the number of units of the second level and a width of the first and second condensed regions; and
sizing the width of the first and second condensed regions proportional to the number of units of the first level and the width of the fanned region.

10. The method of claim 8, wherein the scrubber further includes a marker representing a given location in the item of content.

11. The method of claim 8, wherein the scrubber further includes a handle representing a current location in the item of content.

12. The method of claim 11, wherein the handle is operable for selecting any location in the item of content.

13. The method of claim 12, wherein the section of the item of content is presented on the first portion of the display corresponds to the current location associated with the handle.

14. The method of claim 8, wherein the scrubber further includes a supplemental data window displaying data concerning the first or second level of the item of content.

15. One or more computing device readable media having computing device executable instructions stored thereon that, when executed by one or more processing units, perform a method comprising:
presenting a section of an item of content on a first portion of a display;
presenting a scrubber on a second portion of the display, wherein the scrubber includes,
a first condensed region representing a first set of chapters of the item of content;
a fanned region representing pages of a given chapter of the item of content; and
a second condensed region representing a second set of chapters of the item of content; and
wherein the first condensed region, the fanned region and second condensed region are linearly arranged in the second portion of the display, and
wherein the representation of pages of the given chapter occurs sequentially between the chapters of the first and second sets.

16. The one or more computing device readable media having computing device executable instructions stored thereon that, when executed by the one or more processing units, perform the method according to claim 15, further comprising:
sizing a width of the fanned region proportional to the number of pages in the given chapter and a width of the first and second condensed regions; and
sizing the width of the first and second condensed regions proportional to the number of chapters and the width of the fanned region.

17. The one or more computing device readable media having computing device executable instructions stored thereon that, when executed by the one or more processing units, perform the method according to claim 15, wherein,
the scrubber further includes a handle representing a current location in the item of content,
the handle is operable for selecting, any location in the item of content, and
the section of the item of content presented on the first portion of the display corresponds to the current location associated with the handle.

18. The one or more computing device readable media having computing device executable instructions stored thereon that, when executed by the one or more processing units, perform the method according to claim 16, wherein the scrubber further includes a marker representing a last page read in the item of content or a last page displayed in the item of content before selection of any location in die item of content using the handle.

19. The one or more computing device readable media having computing device executable instructions stored thereon that, when executed by the one or more processing units, perform the method according to claim 15, wherein the scrubber further includes a supplemental data window displaying data concerning the pages or chapter of the item of content.

20. The one or more computing device readable media having computing device executable instructions stored thereon that, when executed by the one or more processing units, perform the method according to claim 15, wherein the scrubber further includes a landmark representing a bookmarked page, a dog-eared page or an annotated page.

21. The one or more computing device readable media having computing device executable instructions stored thereon that, when executed by the one or more processing units, perform the method according to claim 15, wherein
a first color and a first level of magnification are applied to the first and second condensed regions; and
a second color and it second level of magnification are applied to the fanned region.
